(19) United States
(12) Patent Application Publication
(10) Pub. No.: US 2014/0185948 A1
(43) Pub. Date: Jul. 3, 2014

(54) METHOD FOR STORING MOTION PREDICTION-RELATED INFORMATION IN INTER PREDICTION METHOD, AND METHOD FOR OBTAINING MOTION PREDICTION-RELATED INFORMATION IN INTER PREDICTION METHOD

(71) Applicants: Chung Ku Yie, Incheon (KR); Yong Jae Lee, Seoul (KR); Hui Kim, Namyangju-si (KR)

(72) Inventors: Chung Ku Yie, Incheon (KR); Yong Jae Lee, Seoul (KR); Hui Kim, Namyangju-si (KR)

(73) Assignee: HUMAX CO., LTD., Seongnam-si, Gyeonggi-do (KR)

(21) Appl. No.: 14/115,568

(22) PCT Filed: May 31, 2012
(86) PCT No.: PCT/KR2012/004318

§ 371 Date: Feb. 7, 2014

(30) Foreign Application Priority Data
May 31, 2011 (KR) 10-2011-0052418
May 31, 2011 (KR) 10-2011-0052419

(51) Int. Cl. H04N 19/51

(52) U.S. Cl. CPC H04N 19/00587
USPC 382/238

(57) ABSTRACT

Provided are methods for storing and obtaining motion prediction-related information in inter motion prediction method. The method for storing the motion prediction-related information may include obtaining size information of prediction unit of a picture, and adaptively storing motion prediction-related information of the picture on the basis of the obtained size information of prediction unit of the picture. The method for obtaining the motion prediction-related information may include searching a first temporal motion prediction candidate block to obtain first temporal motion prediction-related information in the first temporal motion prediction candidate block, and searching a second temporal motion prediction candidate block to obtain second temporal motion prediction-related information in the second temporal motion prediction candidate block. Thus, a memory space for storing the motion prediction-related information may be efficiently utilized. Also, an error between the prediction block and an original block may be reduced to improve coding efficiency.

### TECHNICAL FIELD

The present invention related to inter prediction methods, and particularly to, methods of storing motion prediction-related information. Further, the present invention is related to inter prediction methods, and more specifically, to motion prediction-related information producing method.

### BACKGROUND ART

In general, image compression method uses inter prediction and intra prediction technology that removes duplicity of pictures so as to raise compression efficiency.

An image encoding method using intra prediction predicts a pixel value using inter-block pixel correlation from pixels in an previously encoded block (for example, upper, left, left and upper and right and upper blocks with respect to a current block) positioned adjacent to a block to be currently encoded and transmits a prediction error of the pixel value.

Further, intra prediction encoding selects an optimal prediction mode among a number of prediction directions (e.g., horizontal, vertical, diagonal, or average) so as to fit into the characteristics of an image to be encoded.

An image encoding method using inter prediction is a method of compressing an image by removing temporal duplicity between pictures and a representative example thereof is a motion compensation prediction encoding method.

### DISCLOSURE

### Technical Problem

In the existing inter-frame motion prediction methods, the size of a prediction unit basis has not been considered in storing motion prediction-related information such as reference picture information or motion vector information of a reference picture for motion prediction.

Accordingly, a first object of the present invention is to provide a method of storing motion prediction-related information in an inter prediction method considering the size of the prediction unit.

Further, a second object of the present invention is to provide a motion vector prediction method and a motion vector decoding method that may reduce the amount of computation of motion vector prediction using a motion vector in a previous frame when performing inter prediction on a current block.

Still further, a third object of the present invention is to provide a motion vector prediction method and a motion vector decoding method that may enhance encoding efficiency by increasing accuracy of motion vector prediction.

The objects of the present invention are not limited thereto, and other objects are apparent to those skilled in the art from the following description.

### Technical Solution

To achieve the above-described first object of the present invention, according to an aspect of the present invention, a method of producing motion prediction-related information in inter prediction include obtaining size information of prediction unit of a picture and adaptively storing motion prediction-related information of the picture based on the obtained size information of prediction unit of the picture. The obtaining the size information of prediction unit of the picture may include obtaining information on a most frequent prediction unit size of the picture, which is a prediction unit size most present in the picture. The method may further include generating a prediction block of a current prediction unit using motion prediction-related information adaptively stored depending on the most frequent prediction unit size of the picture as motion prediction-related information of a first temporal candidate motion prediction unit and a second temporal candidate motion prediction unit. Obtaining the size information of prediction unit of the picture may include obtaining information regarding a prediction unit size having a median value of sizes of prediction units present in the picture. The method may further include generating a prediction block of a current prediction unit using motion prediction-related information adaptively stored depending on the prediction unit size having the median value of the sizes of the prediction units present in the picture as motion prediction-related information of the first temporal candidate motion prediction unit and the second temporal candidate motion prediction unit. Adaptively storing the motion prediction-related information of the picture based on the obtained size information of prediction unit of the picture may further include, in a case where the prediction unit size of the picture is 16×16 or less, storing the motion prediction-related information of the picture on a 16×16 size basis and in a case where the prediction unit size of the picture is more than 16×16, storing the motion prediction-related information of the picture based on the most frequent prediction unit size of the picture that is a prediction unit size most present in the picture. Adaptively storing the motion prediction-related information of the picture based on the obtained size information of prediction unit of the picture may include obtaining a prediction unit having a median value of the prediction unit sizes of the picture and storing motion-related information based on the prediction unit size of the median size for a prediction unit having a size equal to or smaller than the median value among prediction units of the picture and obtaining a prediction unit having a median value of the prediction unit sizes of the picture and storing motion-related information based on the individual prediction unit size for a prediction unit having a size larger than the median value among prediction units of the picture.

To achieve the above-described second object of the present invention, according to an aspect of the present invention, a method of producing motion prediction-related information in an inter prediction method may include exploring a first temporal motion prediction candidate block and producing first temporal motion prediction-related information from the first temporal motion prediction candidate block and exploring a second temporal motion prediction candidate block and producing second temporal motion prediction-related information from the second temporal motion prediction candidate block. The method may further include producing temporal motion prediction-related information for generating a prediction block of a current prediction unit based on the first temporal motion prediction-related information and the second temporal motion prediction-related information. The first temporal motion prediction-related information may be motion prediction-related information of a co-located block of a central prediction block of the current prediction unit. The second temporal motion prediction-related information may be motion prediction-related information of a co-located block of a prediction unit including a pixel positioned at a location that is one-step shifted upwardly and one-step shifted to the left from a leftmost pixel of the current prediction unit. Obtaining the temporal motion prediction-related information for generating a prediction block of a current prediction unit based on the first temporal motion prediction-related information and the second temporal motion prediction-related information may include producing a value obtained by using reference picture information of the first temporal motion prediction-related information and reference picture information of the second temporal motion prediction-related information as reference picture information of the current prediction unit and averaging first motion vector information included in the first temporal motion prediction-related information and second motion vector information included in the second temporal motion prediction-related information as temporal motion prediction-related information for generating a prediction block of the current prediction unit.

### Advantageous Effects

In accordance with the method of storing motion prediction-related information in the above-described inter prediction method, motion prediction-related information such as reference picture information and motion vector information of a prediction unit is adaptively stored based on the distribution in size of the prediction unit, so that memory space may be efficiently used and computational complexity may be reduced upon inter prediction.

Further, in accordance with the method of producing motion prediction-related information in the above-described inter prediction method, an error between the prediction block and the original block may be reduced by a method utilizing motion prediction-related information of the same position blocks located at various places, not the motion prediction-related information produced at one same position block when producing the motion-related information of a current prediction unit, thereby enhancing encoding efficiency.

### DESCRIPTION OF DRAWINGS

FIG. 1 is a conceptual view illustrating a spatial prediction method among inter prediction methods according to an embodiment of the present invention.

FIG. 2 is a conceptual view illustrating a temporal prediction method among inter prediction methods according to an embodiment of the present invention.

FIG. 3 is a conceptual view illustrating a temporal prediction method among inter prediction methods according to an embodiment of the present invention.

FIG. 4 is a flowchart illustrating a method of adaptively storing a motion vector size depending on prediction unit size according to an embodiment of the present invention.

FIG. 5 is a conceptual view illustrating a spatial prediction method among inter prediction methods according to an embodiment of the present invention.

FIG. 6 is a conceptual view illustrating a method of producing first temporal motion prediction-related information among inter prediction methods according to an embodiment of the present invention.

FIG. 7 is a conceptual view illustrating a method of producing second temporal motion prediction-related information among inter prediction methods according to an embodiment of the present invention.

### BEST MODE

Various modifications may be made to the present invention and the present invention may have a number of embodiments. Specific embodiments are described in detail with reference to the drawings.

However, the present invention is not limited to specific embodiments, and it should be understood that the present invention includes all modifications, equivalents, or replacements that are included in the spirit and technical scope of the present invention.

The terms “first” and “second” may be used to describe various components, but the components are not limited thereto. These terms are used only to distinguish one component from another. For example, the first component may be also named the second component, and the second component may be similarly named the first component. The term “and/or” includes a combination of a plurality of related items as described herein or any one of the plurality of related items.

When a component is “connected” or “coupled” to another component, the component may be directly connected or coupled to the other component. In contrast, when a component is directly connected or coupled to another component, no component intervenes.

The terms used herein are given to describe the embodiments but not intended to limit the present invention. A singular term includes a plural term unless otherwise stated. As used herein, the terms “include” or “have” are used to indicate that there are features, numerals, steps, operations, components, parts or combinations thereof as described herein, but do not exclude the presence or possibility of addition of one or more features, numerals, steps, operations, components, parts or components thereof.

Unless defined otherwise, all the terms including technical or scientific terms as used herein have the same meanings as those generally understood by one of ordinary skill in the art. Such terms as generally defined in the dictionary should be interpreted as having meanings consistent with those understood in the context of the related technologies, and should not be construed as having excessively formal or ideal meanings unless clearly defined in the instant application.

Hereinafter, preferred embodiments of the present invention will be described in detail with reference to the accompanying drawings. For better understanding of the entire invention, the same references are used to denote the same elements throughout the drawings, and description thereof is not repeated.

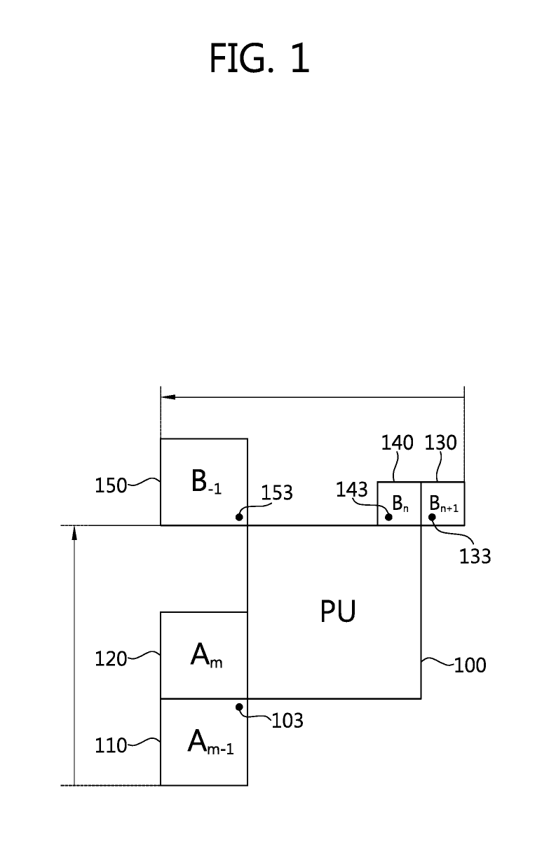

FIG. 1 is a conceptual view illustrating a spatial prediction method among inter prediction methods according to an embodiment of the present invention.

Referring to FIG. 1, motion-related information of prediction units 110, 120, 130, 140, and 150 positioned adjacent to a current prediction unit (PU) 100 may be used to generate a prediction block of the current prediction unit 100.

A first candidate block group may include a prediction unit 110 including a pixel 103 that is positioned one-step lower than a pixel positioned at a lower and left side of the prediction unit and a prediction unit 120 including a pixel positioned higher than the pixel 103 by at least the size of the prediction unit.

The second candidate block group may include a prediction unit 130 including a pixel 133 positioned at a right and upper end of the prediction unit, a prediction unit 140 including a pixel 143 shifted by the minimum prediction unit size to the left of the pixel 133 positioned at the right and upper end of the prediction unit and a prediction unit 150 including a pixel 153 positioned at an upper and left side of the prediction unit.

Among the prediction units included in the first and second candidate block groups, a prediction unit meeting a predetermined condition may be a spatial motion prediction candidate block that may provide motion-related information for generating a prediction block of a current prediction unit.

For a prediction unit included in the first and second candidate block groups (hereinafter, referred to as “spatial candidate motion prediction unit”) to be a spatial candidate motion prediction unit that may provide motion prediction-related information, the spatial candidate motion prediction unit present at the corresponding location should be a block that performs inter prediction and the reference frame of the spatial candidate motion prediction unit should be the same as the reference frame of the current prediction unit.

Based on a spatial candidate motion prediction unit satisfying the condition in which the spatial candidate motion prediction unit should be a block performing inter prediction (hereinafter, “first condition”) and the condition in which the reference frame of the spatial candidate motion prediction unit should be the same as the reference frame of the current prediction unit (hereinafter, “second condition”), the motion prediction block of the current prediction unit may be generated.

In case the motion vector size of a spatial candidate motion prediction unit meeting conditions 1 and 2 is identical to the motion vector size of the current prediction unit, motion-related information such as motion vector or reference frame index of the spatial candidate motion prediction unit meeting the conditions may be used as the motion-related information of the current prediction unit in order to generate a prediction block.

Unless the motion vector size of the spatial candidate motion prediction unit meeting conditions 1 and 2 is identical to the motion vector size of the current prediction unit, the same information as the motion-related information of the current prediction unit and the reference frame index of the spatial candidate motion prediction unit meeting the conditions may be used as motion-related information of the current prediction unit.

The motion vector size of the current prediction unit may generate the prediction block of the current prediction unit by producing the motion vector value of the current prediction unit based on information on the distance between reference pictures and information on a difference value between the motion vector of the current prediction unit and the motion vector of the spatial candidate motion prediction unit.

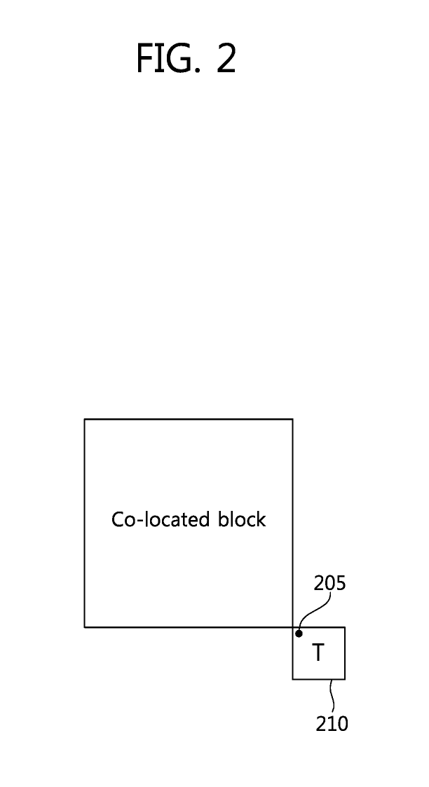

FIG. 2 is a conceptual view illustrating a temporal prediction method among inter prediction methods according to an embodiment of the present invention.

Referring to FIG. 2, in order to generate a prediction block of a current prediction unit, a motion vector and reference picture information may be obtained for predicting the current prediction unit from a prediction unit present before or after the current prediction unit.

A first temporal candidate motion prediction unit 210 may be a prediction unit that includes a pixel 205 positioned at the same location as a pixel shifted to the right and positioned one step lower from the lowermost and rightmost pixel of the current prediction unit in the reference picture.

If a motion vector is difficult to obtain from the first temporal candidate motion prediction unit as if the first temporal candidate motion prediction unit is subjected to intra prediction, other temporal candidate motion prediction unit may be used for predicting the current prediction unit.

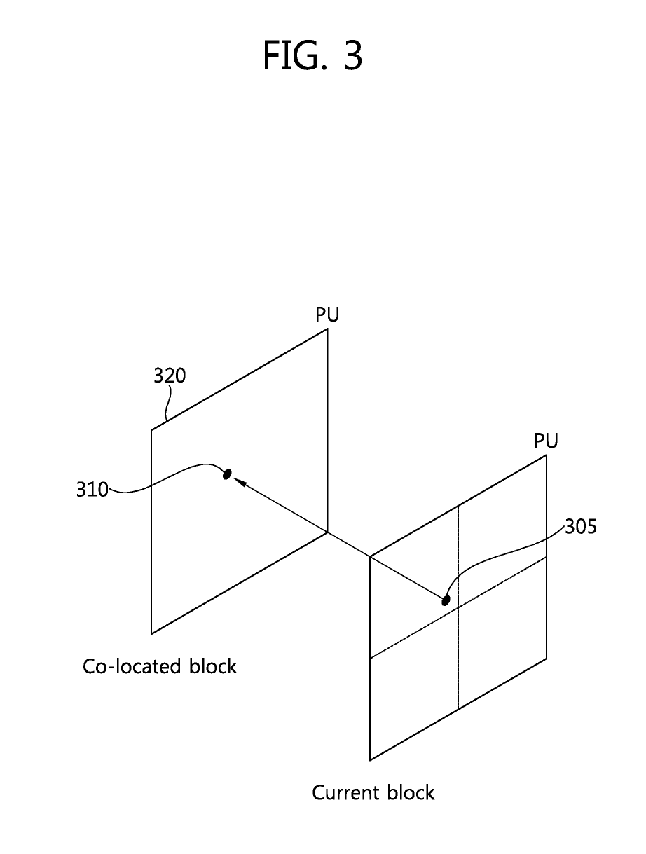

FIG. 3 is a conceptual view illustrating a temporal prediction method among inter prediction methods according to an embodiment of the present invention.

Referring to FIG. 3, a second temporal candidate motion prediction unit may produce a prediction unit of a reference picture based on a pixel 305 present at a position that is shifted to the right and lower side by half the horizontal and vertical size of the current prediction unit from the uppermost and rightmost pixel of the current prediction unit and is then one-step shifted to the left and upper side—hereinafter, this pixel is referred to as “central pixel.” The second temporal candidate motion prediction unit 310 may be a prediction unit 320 that includes a pixel 310 positioned at the same location as the central pixel in the reference picture.

For example, in case the first temporal candidate motion prediction unit is a prediction unit using intra prediction so it is impossible to use the first temporal candidate motion prediction unit, the second temporal candidate motion prediction unit may be used as a temporal candidate motion prediction unit for predicting the current prediction unit, and in case both the first and second temporal candidate motion prediction units are impossible to use, the temporal candidate motion prediction method might not be used as a method for motion prediction of the current prediction unit.

The size of the first and second temporal candidate motion prediction units may be changed.

The prediction units present in the reference picture may have sizes of 4×4, 4×8, 8×4, 8×8, 8×16, 16×8, 16×16, 16×32, 32×16, and 32×32, and thus, the first or second temporal candidate motion prediction unit may have various sizes such as 4×4, 4×8, 8×4, 8×8, 8×16, 16×8, 16×16, 16×32, 32×16, and 32×32.

In the inter prediction method according to an embodiment of the present invention, the method of storing motion prediction-related information stores a motion vector value for performing inter prediction on the current prediction unit with the size of the basic prediction unit for storing motion vectors changed based on the prediction unit information of the picture.

An image decoder may store motion prediction-related information per prediction unit in a memory based on the prediction unit information of the picture.

The prediction unit-related information of the picture may be transferred from the image encoder to the image decoder as additional information, or rather than being transferred from the image encoder as additional information, a prediction picture may be generated in the image decoder and then prediction unit information of the picture may be newly produced.

In the inter prediction method according to an embodiment of the present invention, the motion-related information storing method stores motion prediction-related information based on prediction units having a size of 16×16 in case the size of most of prediction units included in a current picture is smaller than 16×16. If the size of most of the prediction units included in the current picture is larger than 16×16, for example, 16×32, 32×16, or 32×32, the motion vectors of the prediction units may be stored based on the size of most of the prediction units. That is, in case the size of most of prediction units in a reference picture is 32×32, the motion vectors of the prediction units may be stored based on the 32×32 size.

In other words, in case the prediction unit size of the picture is equal to or smaller than 16×16 in order to adaptively store the motion prediction-related information of the picture based on the size information of prediction unit of the produced picture, the motion prediction-related information of the picture is stored on a 16×16 size basis, and in case the prediction unit size of the picture is larger than 16×16, the motion prediction-related information of the picture may be stored based on the picture's most frequent prediction unit size that is the size owned by a majority of prediction units in the picture.

By adaptively storing motion vectors according to the prediction unit size which most of prediction units in the picture has, the memory space necessary for storing motion vectors may be efficiently utilized.

According to an embodiment of the present invention, other methods of adaptively storing motion-related information based on the information on prediction units included in a picture may also be used. For example, in case each prediction unit in a picture has a size of only 4×4 to 16×16, a median value of the sizes of the prediction units, for example, 8×8, may be used as a reference, so that a prediction unit having a size of 8×8 or lower stores motion-related information based on the prediction unit having the 8×8 size, and a prediction unit having a size of 8×8 or more stores motion-related information based on the original prediction unit.

In other words, in order to adaptively store motion prediction-related information of the picture based on the size information of prediction unit of the picture, a prediction unit having a median value of the sizes of prediction units in the picture is produced, so that a prediction unit with a size of the median value or less, among the prediction units in the picture, stores motion-related information based on the prediction unit size of the median value, and a prediction unit having the median value of sizes of the prediction units in the picture is produced, so that a prediction unit having a size of the median value or more, among the prediction units in the picture, may store motion-related information based on the size of each prediction unit.

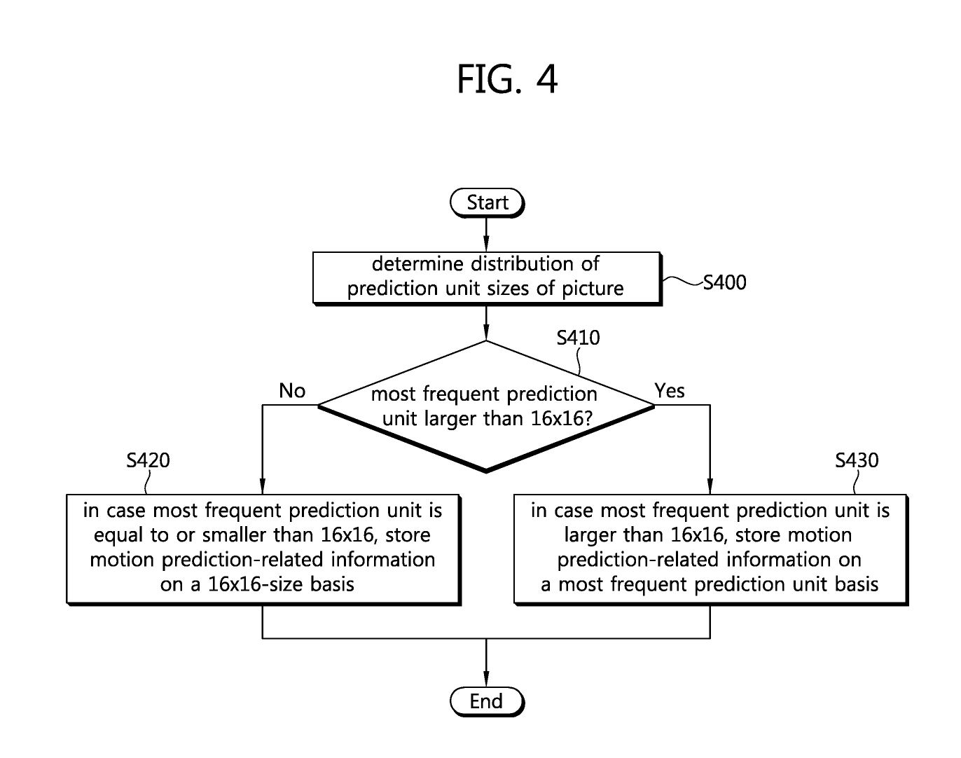

FIG. 4 is a flowchart illustrating a method of adaptively storing a motion vector size depending on prediction unit size according to an embodiment of the present invention.

Although in FIG. 4 the motion prediction-related information is stored based on a most frequent prediction unit, storing motion prediction-related information based on a median value as described above is also within the scope of the present invention. Further, although it is assumed that an image decoder determines and stores the size information of prediction unit of a picture, the image decoder may directly use the size information of prediction unit of the picture transferred as additional information.

Referring to FIG. 4, the distribution of the sizes of prediction unit in the picture is determined (step S400).

The prediction units in the picture may be intra prediction units that have undergone intra prediction or inter prediction units that have undergone inter prediction. In the inter prediction method according to an embodiment of the present invention, the motion prediction-related information storing method may determine which one of sizes of prediction units in the picture, such as 4×4, 4×8, 8×4, 8×8, 8×16, 16×8, 16×16, 16×32, 32×16, and 32×32, is most frequently used for the inter prediction units (hereinafter, referred to as “most frequent prediction unit”).

It is determined whether the most frequent prediction unit has a size larger than 16×16 (step S410).

The case in which the most frequent prediction unit has a size of 16×16 or less and the case in which the most frequent prediction unit has a size of 16×16 may be distinguished from each other, so that the motion-related information of the prediction units included in the current picture (motion vector, reference picture, etc.) is stored differently for each prediction unit. Accordingly, memory may be effectively utilized, and complexity of inter prediction may be reduced.

In case the most frequent prediction unit has a size of 16×16 or less, the motion prediction-related information is stored on a 16×16 basis (step S420).

In case the most frequent prediction unit has a size of 16×16 or less, such as 4×4, 4×8, 8×4, 8×8, 8×16, 16×8, and 16×16, the motion prediction-related information such as motion vector and reference picture information is stored on a 16×16 size basis.

In case the motion prediction unit has a size smaller than 16×16, such as 4×4, 4×8, 8×4, 8×8, 8×16, and 16×8, one of prediction units having the corresponding 16×16 size may be stored, or a motion vector and reference picture may be newly produced using a predetermined equation for prediction units having the corresponding 16×16 size so that motion prediction-related information may be stored for each prediction unit having the 16×16 size.

In case the most frequent prediction unit has a size larger than 16×16, the motion prediction-related information is stored based on the most frequent prediction unit (step S430).

For example, in case the prediction unit size most frequently used in the current picture is 32×32, the motion prediction-related information may be stored on a 32×32 size basis.

In case the prediction unit has the 32×32 size, the motion vector value of the corresponding prediction unit may be used as the motion vector value of the current prediction unit.

The motion-related information of the prediction unit having the 32×32 size that is smaller than the 32×32 size may be produced as one piece of motion-related information. For example, a 32×32-size prediction unit including a plurality of 16×16-size prediction units may utilize the motion prediction-related information of one of the plurality of 16×16-size prediction units as motion prediction-related information on a 32×32 size basis or may utilize a value obtained by interpolating the motion-related information of the plurality of 16×16-size prediction unit as motion prediction-related information on a 32×32 size basis.

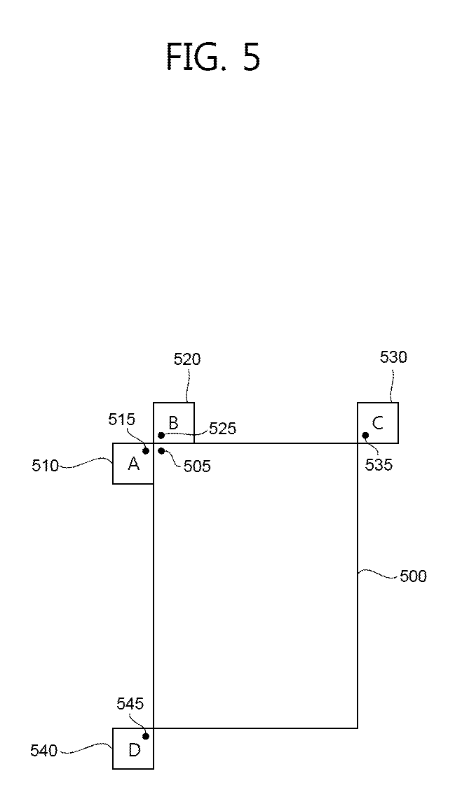

FIG. 5 is a conceptual view illustrating a spatial prediction method among inter prediction methods according to an embodiment of the present invention.

Referring to FIG. 5, in order to generate a prediction block of a current prediction unit 500, the motion-related information of prediction units 510, 520, 540, and 550 positioned adjacent to the current prediction unit 500 may be used.

As spatial motion prediction candidate blocks, four blocks adjacent to the current block may be used.

The first spatial motion prediction candidate block 510 may be a prediction unit including a pixel 515 that is one-step shifted to the left from the uppermost and leftmost pixel 505 of the current prediction unit.

The second spatial motion prediction candidate block 520 may be a prediction unit including a pixel 525 that is one step shifted to the upper side from the uppermost and leftmost pixel 505 of the current prediction unit.

The third spatial motion prediction candidate block 530 may be a prediction unit including a pixel 535 that is positioned at a location that is shifted by the horizontal size of the current prediction unit from the uppermost and leftmost pixel 505 of the current prediction unit.

The fourth spatial motion prediction candidate block 540 may be a prediction unit including a pixel 545 that is positioned at a location that is shifted by the vertical size of the current prediction unit from the uppermost and leftmost pixel 505 of the current prediction unit.

If, for example, the motion prediction-related information of the third spatial motion prediction candidate block 530, for example, motion vector, reference picture information is the same as the motion prediction-related information of the current prediction unit, the motion prediction-related information of the third spatial motion prediction candidate block 530 may be used as the motion prediction-related information of the current prediction unit.

That is, in case among the first to fourth spatial motion prediction candidate blocks 510, 520, 530, and 540, there is a motion prediction candidate block having the same motion prediction-related information as the current prediction unit 500, the motion prediction information of the motion prediction candidate block having the same motion-related information as the current prediction unit 500 may be used as the motion prediction-related information of the current prediction unit 500.

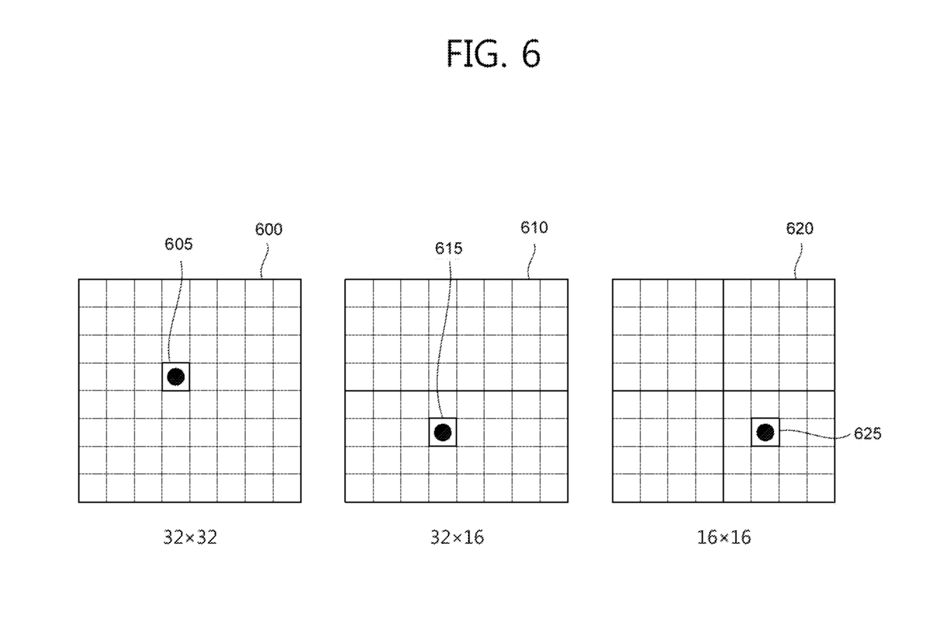

FIG. 6 is a conceptual view illustrating a method of producing first temporal motion prediction-related information among inter prediction methods according to an embodiment of the present invention.

In order to generate prediction blocks of current prediction units 600, 610, and 620, motion vectors and reference picture information for predicting the current prediction units may be obtained from prediction units present in a picture present before or after the current prediction units 600, 610, and 620.

To obtain the motion vector and reference picture information for predicting current prediction units from the prediction units in a previous or subsequent picture of the current prediction units 600, 610, and 620, the motion prediction-related information of a block (hereinafter, referred to as “co-located block”) of the previous or subsequent picture positioned at the same location as a block having a specific size that is positioned at the center of the current prediction unit may be used as prediction unit for predicting a temporal motion prediction method of the current prediction unit.

Referring to FIG. 6, the position of the block included in the current prediction unit to obtain the motion prediction-related information from the co-located block may vary depending on the size of the current prediction unit.

In FIG. 6, the left-hand prediction unit 600 shows a block 605 (hereinafter, referred to as central prediction block) having a size of 4×4 that is positioned at the center of the current prediction unit for producing the co-located block in case the 32×32 size prediction unit is used.

In FIG. 6, the middle and right-hand prediction units 610 and 620, respectively, show 4×4 size blocks 615 and 625 (hereinafter, “central prediction blocks”) positioned at the center of the current prediction unit in case prediction unit sizes such as 32×16 and 16×16 are used.

Assuming the current prediction unit has a size of 32×32, the motion-related information of the co-located block of the current central prediction block 605 (a block present at the same location as the current central prediction block in a previous or subsequent picture of the current picture) may be used as motion prediction-related information for generating the prediction block of the current prediction unit.

In case the prediction unit has a size other than 32×32, the motion prediction-related information of the coding unit may be produced at the co-located block of the central prediction blocks 615 and 625 of the current prediction unit. Hereinafter, according to an embodiment of the present invention, the temporal motion-related information produced from the central prediction blocks 605, 615, and 625 is defined as first temporal motion prediction-related information.

According to an embodiment of the present invention, the motion prediction-related information of the co-located block of the block positioned at the upper and left side of the current prediction unit, as well as the above-described prediction block may be used to produce the motion prediction-related information of the current prediction unit.

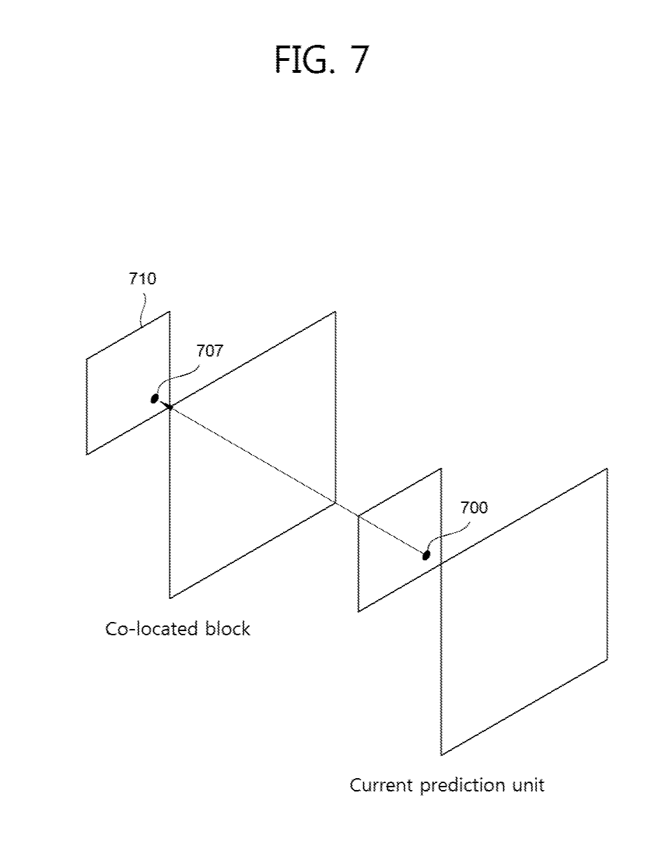

FIG. 7 is a conceptual view illustrating a method of producing second temporal motion prediction-related information among inter prediction methods according to an embodiment of the present invention.

Referring to FIG. 7, the motion prediction-related information of a co-located block 710 of a prediction unit including a pixel 707 positioned at the same location on the reference picture as a pixel 700 present at the location that is one-step shifted to the left and upper end from the uppermost and leftmost pixel of the current prediction unit may be used to perform motion prediction on the current prediction unit.

Hereinafter, according to an embodiment of the present invention, the temporal motion-related information produced from the co-located block 710 of a prediction unit including a pixel 707 positioned at the same location on the reference picture as a pixel 700 present at the location that is one-step shifted to the left and upper end from the uppermost and leftmost pixel of the current prediction unit is defined as second temporal motion prediction-related information.

Based on the above-described first temporal motion prediction-related information and the second temporal motion prediction-related information, one piece of motion prediction-related information for producing the current prediction unit may be obtained and may be used to generate the prediction block of the current prediction unit.

In case both the first and second temporal motion prediction-related information are available, the motion vector included in the first and second temporal motion prediction-related information may be used as motion prediction-related information for performing motion prediction of the current prediction unit.

For example, in case the first temporal motion prediction-related information is the same as the second temporal motion prediction-related information, the corresponding reference picture may be used as reference picture information for performing motion prediction on the current prediction unit, and an average value of the motion vector of the first temporal motion prediction-related information and the motion vector of the second motion prediction-related information or a motion vector value newly produced based on some equation may be used as motion prediction-related information for performing motion prediction on the current prediction unit. That is, although according to an embodiment of the present invention, for purposes of description, the above-described averaging method is adopted as the method of producing the motion vector of the current prediction unit, other methods may be adopted—for example, a predetermined equation may be used to produce a motion vector that may be then used as a motion vector for predicting the current prediction unit.

In case the reference picture information of the first temporal motion prediction-related information is different from the reference picture information of the second temporal motion prediction-related information, the motion vector and reference picture information of one of the reference picture information of the first temporal motion prediction-related information and the reference picture information of the second temporal motion prediction-related information may be used to generate the prediction block of the current prediction unit. Further, in case only one of the first temporal motion prediction-related information and the second temporal motion prediction-related information is available, the available temporal motion prediction-related information may be used as temporal motion prediction-related information of the current prediction unit.

That is, the image decoder may receive from the image encoder or may obtain on its own the available temporal motion prediction candidate block information of the first temporal motion prediction candidate block or second temporal motion prediction candidate block and may then generate the prediction block for the current prediction unit based on at least one of the first temporal motion prediction-related information or second temporal motion prediction-related information of the first temporal motion prediction candidate block or the second temporal motion prediction candidate block.

By the above-described methods, when producing the motion-related information of the current prediction unit, not only the motion-related information of the block positioned at the center but also the motion prediction-related information of the motion prediction unit of the prediction unit positioned at the left and upper side may be utilized, so that an error between the prediction block and the original block may be reduced, thus increasing encoding efficiency.

Although embodiments of the present invention have been described, it will be understood by those skilled in the art that various modifications may be made thereto without departing from the scope and spirit of the present invention.

1. A method of producing motion prediction-related information in inter prediction, the method comprising:
obtaining size information of prediction unit of a picture; and
adaptively storing motion prediction-related information of the picture based on the obtained size information of prediction unit of the picture.

2. The method of claim 1, wherein obtaining the size information of prediction unit of the picture includes obtaining information on a most frequent prediction unit size of the picture, which is a prediction unit size most present in the picture.

3. The method of claim 2, further comprising generating a prediction block of a current prediction unit using motion prediction-related information adaptively stored depending on the most frequent prediction unit size of the picture as motion prediction-related information of a first temporal candidate motion prediction unit and a second temporal candidate motion prediction unit.

4. The method of claim 1, wherein obtaining the size information of prediction unit of the picture includes obtaining information regarding a prediction unit size having a median value of sizes of prediction units present in the picture.

5. The method of claim 4, further comprising generating a prediction block of a current prediction unit using motion prediction-related information adaptively stored depending on the prediction unit size having the median value of the sizes of the prediction units present in the picture as motion prediction-related information of the first temporal candidate motion prediction unit and the second temporal candidate motion prediction unit.

6. The method of claim 1, wherein adaptively storing the motion prediction-related information of the picture based on the obtained size information of prediction unit of the picture further comprises,
in a case where the prediction unit size of the picture is 16×16 or less, storing the motion prediction-related information of the picture on a 16×16 size basis; and
in a case where the prediction unit size of the picture is more than 16×16, storing the motion prediction-related information of the picture based on the most frequent prediction unit size of the picture that is a prediction unit size most present in the picture.

7. The method of claim 1, wherein adaptively storing the motion prediction-related information of the picture based on the obtained size information of prediction unit of the picture comprises,
obtaining a prediction unit having a median value of the prediction unit sizes of the picture and storing motion-related information based on the prediction unit size of the median size for a prediction unit having a size equal to or smaller than the median value among prediction units of the picture; and
obtaining a prediction unit having a median value of the prediction unit sizes of the picture and storing motion-related information based on the individual prediction unit size for a prediction unit having a size larger than the median value among prediction units of the picture.

8. A method of producing motion prediction-related information in an inter prediction method, the method comprising:
exploring a first temporal motion prediction candidate block and producing first temporal motion prediction-related information from the first temporal motion prediction candidate block; and
exploring a second temporal motion prediction candidate block and producing second temporal motion prediction-related information from the second temporal motion prediction candidate block.

9. The method of claim 8, further comprising producing temporal motion prediction-related information for generating a prediction block of a current prediction unit based on the first temporal motion prediction-related information and the second temporal motion prediction-related information.

10. The method of claim 8, wherein the first temporal motion prediction-related information is motion prediction-related information of a co-located block of a central prediction block of the current prediction unit.

11. The method of claim 8, wherein the second temporal motion prediction-related information is motion prediction-related information of a co-located block of a prediction unit including a pixel positioned at a location that is one-step shifted upwardly and one-step shifted to the left from a leftmost pixel of the current prediction unit.

12. The method of claim 8, wherein obtaining the temporal motion prediction-related information for generating a prediction block of a current prediction unit based on the first temporal motion prediction-related information and the second temporal motion prediction-related information includes producing a value obtained by using reference picture information of the first temporal motion prediction-related information and reference picture information of the second temporal motion prediction-related information as reference picture information of the current prediction unit and averaging first motion vector information included in the first temporal motion prediction-related information and second motion vector information included in the second temporal motion prediction-related information as temporal motion prediction-related information for generating a prediction block of the current prediction unit.
